(19) United States
(12) Patent Application Publication
(10) Pub. No.: US 2025/0271103 A1
(43) Pub. Date: Aug. 28, 2025

(54) GAS TANK STRUCTURE

(71) Applicant: TOYOTA JIDOSHA KABUSHIKI KAISHA, Toyota-shi (JP)

(72) Inventors: Yuki KAI, Nagoya-shi (JP); Osamu Sawai, Okazaki-shi (JP)

(73) Assignee: TOYOTA JIDOSHA KABUSHIKI KAISHA, Toyota-shi (JP)

(21) Appl. No.: 18/967,661

(22) Filed: Dec. 4, 2024

(30) Foreign Application Priority Data
Feb. 22, 2024 (JP) 2024-025190

(51) Int. Cl. F17C 1/00

(52) U.S. Cl. CPC F17C 1/00; F17C 2201/0166; F17C 2205/0146; F17C 2221/012

(57) ABSTRACT

The gas tank structure includes gas tanks arranged side by side in one direction in a state in which adjacent gas tanks are in contact with each other, lid-like members provided in one-to-one correspondence with the gas tanks and mounted at respective ends of the gas tanks, the lid-like members each having a communication hole communicating with an inside of a corresponding gas tank and a through hole communicating with the communication hole and extending in a direction in which the gas tanks are arranged side by side, and connection pipes each having one end portion inserted into the through-hole of one lid-like member and the other end portion inserted into the through-hole of the other lid-like member so as to connect the adjacent lid-like members, and a seal member which is provided at both ends of each connection pipe and seals between the connection pipe and the lid-like member.

### CROSS-REFERENCE TO RELATED APPLICATION

This application claims priority to Japanese Patent Application No. 2024-025190 filed on Feb. 22, 2024, incorporated herein by reference in its entirety.

### BACKGROUND

### 1. Technical Field

The present disclosure relates to a gas tank structure.

### 2. Description of Related Art

Conventionally, Japanese Patent No. 3911015, for example, is disclosed in this technical field. In the gas tank structure described in Japanese Patent No. 3911015, a plurality of non-cylindrical gas tanks is integrally wound by a sheet in a state of being arranged side by side in one direction.

### SUMMARY

However, in the above-described gas tank structure, the gas tanks are disposed so as to be in contact with each other, and thus a load is applied to adjacent gas tanks when the gas tanks are expanded by gas filling. Further, when a connection pipe for hydrogen gas filling is connected to the gas tanks, the connection pipe is relatively moved by expansion of the gas tanks, positional deviation of the connection pipe occurs, and there is a possibility that the gas filling of the gas tanks is affected.

The present disclosure has been made in view of addressing such a technical issue, and has an object to provide a gas tank structure capable of reducing a load on adjacent gas tanks during expansion of the gas tanks and suppressing an effect on gas filling.

An aspect of the present disclosure provides a gas tank structure including:
a plurality of gas tanks arranged side by side in one direction in a state in which adjacent gas tanks are in contact with each other;
a plurality of lid-like members provided in one-to-one correspondence with the gas tanks and mounted at respective ends of the gas tanks, the lid-like members each having a communication hole communicating with an inside of a corresponding gas tank and a through hole communicating with the communication hole and extending in a direction in which the gas tanks are arranged side by side;
a plurality of connection pipes that connects adjacent lid-like members to each other with one end of the connection pipes inserted into the through hole of one of the lid-like members and another end of the connection pipes inserted into the through hole of another of the lid-like members; and a seal member provided at each of both ends of the connection pipes to seal between the connection pipes and the lid-like members.

In the gas tank structure according to the present disclosure, the lid-like members are provided in one-to-one correspondence with the gas tanks. The connection pipes connect adjacent lid-like members to each other with one end of the connection pipes inserted into the through hole of one of the lid-like members and the other end of the connection pipes inserted into the through hole of the other of the lid-like members. Consequently, the adjacent lid-like members are connected to each other by independent connection pipes. Thus, adjacent gas tanks are relatively easily moved when a load is applied to the adjacent gas tanks by expansion of the gas tanks, and thus a load on the adjacent gas tanks can be reduced when the gas tanks are expanded. Further, at this time, the connection pipes can relatively slide with respect to the lid-like member to which the connection pipes are inserted, and thus it is possible to suppress an effect on the gas filling. Further, the seal member is provided at each of both ends of the connection pipes, and thus the sealing property between the connection pipes and the lid-like members can be maintained even when the connection pipes are relatively slid.

In the gas tank structure according to the present disclosure, preferably,
a gap is provided between adjacent lid-like members; and
the connection pipes have a flange portion that penetrates into the gap.
   According to this configuration, the moving range (sliding range) of the connection pipes can be restricted by using the flange portion, and thus the positional deviation of the connection pipes can be suppressed.

In the gas tank structure according to the present disclosure, preferably,
a protruding portion that restricts a position of the connection pipes to be inserted is provided at a position facing the communication hole, of an inner peripheral wall of the lid-like members forming the through hole.
   According to this configuration, the moving range (sliding range) of the connection pipes can be restricted by using the protruding portion, and thus the positional deviation of the connection pipes can be suppressed.

According to the present disclosure, it is possible to reduce a load on adjacent gas tanks during expansion of the gas tanks, and to suppress an effect on gas filling.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view and a cross-sectional view showing a gas tank structure according to a first embodiment;

FIG. 2 is a cross-sectional view along C-C of FIG. 1;

FIG. 3 is an enlarged cross-sectional view showing a portion D of FIG. 2;

FIG. 4 is a cross-sectional view taken along E-E line of FIG. 3; and

FIG. 5 is a partial cross-sectional view illustrating the gas tank structure according to the second embodiment.

### DETAILED DESCRIPTION OF EMBODIMENTS

Hereinafter, an embodiment of a gas tank structure according to the present disclosure will be described with reference to the drawings. In the description of the drawings, the same elements are denoted by the same reference numerals, and redundant description thereof will be omitted.

### First Embodiment

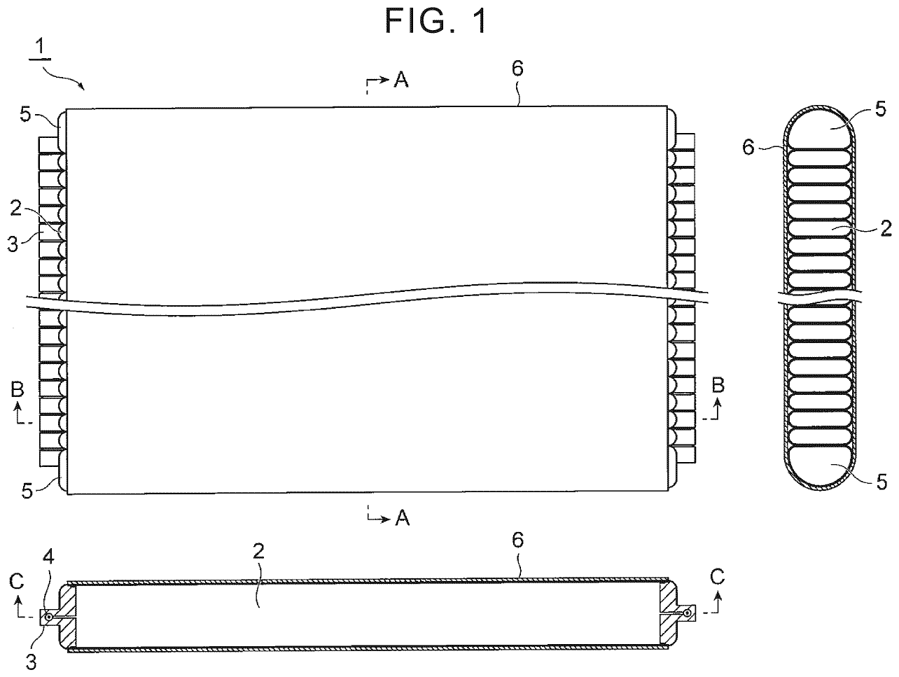

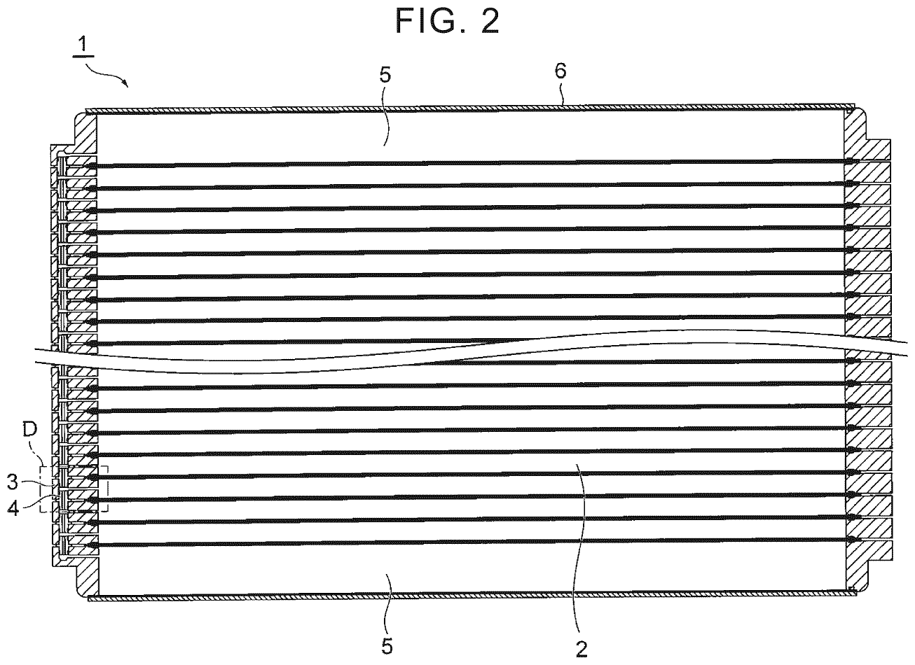

FIG. 1 is a plan view and a cross-sectional view illustrating a gas tank structure according to a first embodiment. In FIG. 1, a cross-sectional view on the right side is a cross-sectional view along a A-A line shown in a plan view, and a cross-sectional view on the lower side is a cross-sectional view along a B-B line shown in a plan view. FIG. 2 is a cross-sectional view taken along C-C line of FIG. 1. The gas tank structure 1 of the present embodiment is, for example, a gas tank structure used in a fuel cell electric vehicle (not shown). The inside of the gas tank 2 is filled with high-pressure hydrogen gas. The gas that can be filled in the tank is not limited to hydrogen gas, and may be compressed gas such as CNG (compressed natural gas), or various types of liquefied gas such as LNG (liquefied natural gas) or LPG (liquefied petroleum gas).

As shown in FIGS. 1 and 2, the gas tank structure 1 of the present embodiment mainly includes a plurality of gas tanks 2 and 5 arranged side by side in one direction, a plurality of lid-like members 3, and a plurality of connection pipes 4 connecting the lid-like members 3 adjacent to each other. The plurality of lid-like members 3 are provided in a one-to-one manner with respect to the plurality of gas tanks 2 and 5, and are attached to the end portions of the gas tanks 2 and 5.

As shown in A-A sectional view of FIG. 1, in the gas tank structure 1 of the present embodiment, two types of deformed tanks (a gas tank 2 and a gas tank 5) are used. The gas tank 2 is a flat tank having a substantially elliptical cross section, and has a relatively large number. The plurality of gas tanks 2 are aligned in one direction in a state in which the adjacent gas tanks are in contact with each other, more specifically, in a state in which the wide walls of the flat tanks are in contact with each other.

On the other hand, the gas tank 5 is a tank having a semicircular cross section and has a pair of left and right sides. The pair of gas tanks 5 are arranged at both ends in the side-by-side direction of the gas tank 2 in a state in which the diameter wall of the tank is in contact with the wide wall of the adjacent gas tank 2. The gas tank 2 and the gas tank 5 are integrated by being wound around a sheet member 6 made of a composite material such as CFRP (Carbon Fiber Reinforced Plastics), for example.

In the following description, the gas tank 2 and the lid-like member 3 attached thereto are exemplified. The shape of the gas tank 5 and the lid-like member attached thereto are different from those of the gas tank 2 and the lid-like member 3, respectively, but the structure is the same, and thus the description thereof will be omitted.

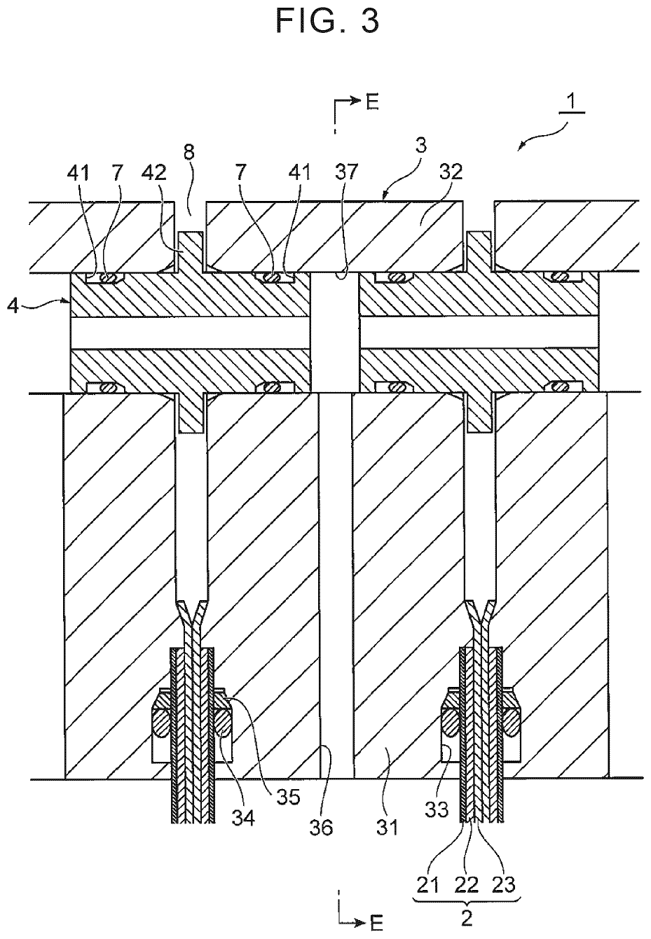

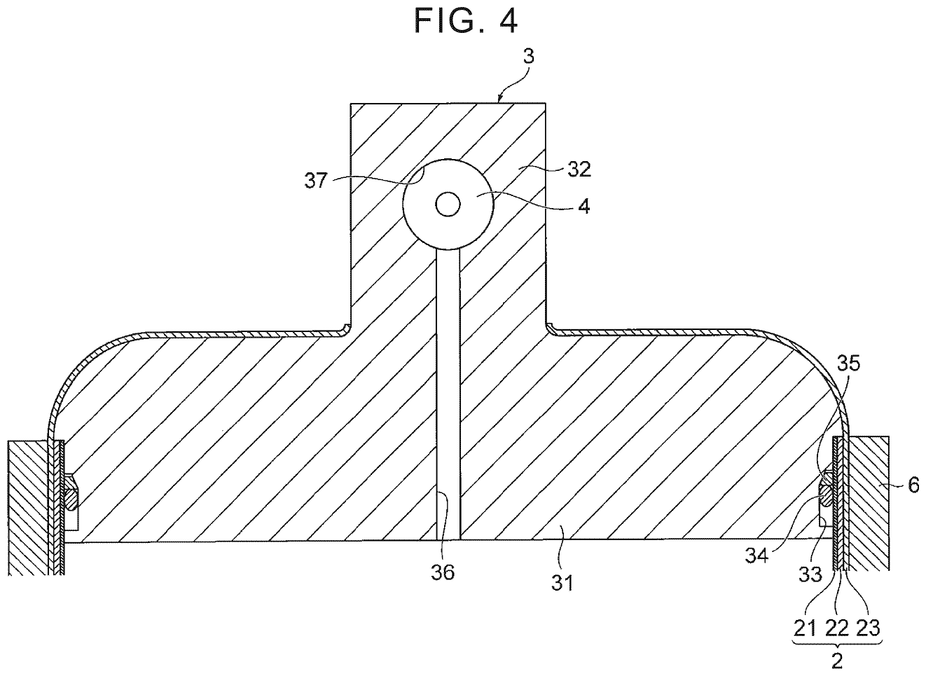

FIG. 3 is an enlarged cross-sectional view showing a portion D of FIG. 2, and FIG. 4 is a cross-sectional view taken along E-E line of FIG. 3. As shown in FIGS. 3 and 4, the gas tank 2 includes a liner 21 which is a hollow container having a storage space for storing high-pressure hydrogen gas, and a first reinforcing layer 22 and a second reinforcing layer 23 which cover the outer peripheral surface of the liner 21. The liner 21 is made of a resin material having a gas barrier property against hydrogen gas. The first reinforcing layer 22 and the second reinforcing layer 23 have a function of reinforcing the liner 21 to improve mechanical strength such as rigidity and pressure resistance of the gas tank 2. The first reinforcing layer 22 and the second reinforcing layer 23 are formed, for example, by winding a plurality of fiber-reinforced resins around the outer peripheral surface of the liner 21 by a filament winding (FW) method.

The lid-like member 3 is made of a metal material such as stainless steel or an aluminum alloy, and is attached to the opening so as to close the opening of the gas tank 2. Specifically, the lid-like member 3 includes an insertion portion 31 that is inserted into the opening of the gas tank 2, and a protrusion portion 32 that is integrally formed with the insertion portion 31 and protrudes from the gas tank 2.

The insertion portion 31 is formed in an elliptical cross section so as to correspond to the gas tank 2, and is held by the liner 21, the first reinforcing layer 22, and the second reinforcing layer 23 in a state of being inserted into an end portion of the gas tank 2. A peripheral groove 33 is formed in an outer peripheral wall of an end portion of the insertion portion 31. An O-ring 34 for sealing between the lid-like member 3 and the gas tank 2 is fitted in the peripheral groove 33. Further, a backup ring 35 disposed outside the gas tank 2 is fitted into the peripheral groove 33 with respect to the O-ring 34. The O-ring 34 and the backup ring 35 are disposed in the peripheral groove 33 in a close state. On the other hand, the protrusion portion 32 is formed in a block shape and stands upright from the insertion portion 31.

Further, the lid-like member 3 has a communication hole 36 communicating with the inside of the gas tank 2, and a through hole 37 communicating with the communication hole 36 and extending in the side-by-side direction of the gas tank 2. The communication hole 36 extends along the axial direction of the gas tank 2, and is formed over the entire length of the insertion portion 31 and a part of the protrusion portion 32. The through-hole 37 extends along a direction in which the gas tank 2 is arranged in parallel (that is, a direction orthogonal to the axial direction of the gas tank 2) so as to have a T-shape with the communication hole 36, and passes through the protrusion portion 32.

The connection pipe 4 is formed of, for example, a resin material in an annular cross section, and has an end portion that can be inserted into the through hole 37 of the lid-like member 3. As shown in FIG. 3, the connection pipe 4 is disposed between the lid-like members 3 adjacent to each other, and one end thereof is inserted into the through hole 37 of one lid-like member 3, and the other end thereof is inserted into the through hole 37 of the other lid-like member 3. Seal members 7 for sealing between the connection pipe 4 and the lid-like member 3 are provided at both end portions of the connection pipe 4. More specifically, recessed grooves 41 are respectively provided in the outer peripheral walls of both end portions of the connection pipe 4. A seal member 7 for sealing between the outer peripheral wall of the connection pipe 4 and the inner peripheral wall of the lid-like member 3 is fitted into each of the recessed grooves 41. For example, an O-ring is used as the seal member 7.

Further, as shown in FIG. 3, in the direction in which the gas tanks 2 are arranged side by side, the adjacent lid-like members 3 are arranged so as to have a gap 8 therebetween. Correspondingly, the connection pipe 4 has a flange portion 42 which penetrates into the gap 8. The flange portion 42 is disposed, for example, at a center position of the connection pipe 4 in the parallel arrangement direction of the gas tank 2, and has an annular shape protruding from the outer peripheral wall of the connection pipe 4.

The reason why the flange portion 42 is provided in the connection pipe 4 will now be described.

As shown in FIG. 3, in a state in which the respective adjacent lid-like members 3 are connected to each other by the connection pipe 4, the connection pipe 4 inserted into the through-hole 37 of the lid-like member 3 may move (e.g., slide) in the through-hole 37 due to the pressure of hydrogen gas or the like. When sliding in this manner, there is a possibility that the end faces of the adjacent connection pipes 4 are excessively close to each other to hinder the inflow of the hydrogen gas into the through-hole 37. In addition, when sliding, there is a possibility that the end faces of the adjacent connection pipes 4 come into contact with each other to close the through-hole 37, or the connection pipe 4 may come out of the through-hole 37. Therefore, by providing a flange portion 42 to the connection pipe 4, by inserting the flange portion 42 into the gap 8 between the lid-like members 3 adjacent, the sliding range of the connection pipe 4 (movement range) is limited, it is possible to suppress the positional deviation of the connection pipe 4. As a result, the above-described problems can be suppressed.

Incidentally, the flange portion 42 is not a structure for prohibiting sliding of the connection pipe 4, when the gas tank 2 is expanded by hydrogen gas filling or the like, it is configured to be able to allow a certain range of slides in the side-by-side direction of the gas tank 2. Therefore, the width of the flange portion 42 in the side-by-side direction of the gas tank 2 is set to be smaller than the width of the gap 8 in accordance with the allowable range of the slide.

In the gas tank structure 1 configured as described above, when the hydrogen gas is filled in the gas tank 2, the hydrogen gas passes through the through-hole 37 of the lid-like member 3 and the connection pipe 4 inserted into the through-hole 37. The hydrogen gas further flows into the gas tank 2 through the communication hole 36 communicating with the through hole 37.

In the gas tank structure 1 according to the present embodiment, the lid-like member 3 is provided on a one-to-one basis with respect to the plurality of gas tanks 2 and 5. The connection pipe 4 connects the lid-like members 3 adjacent to each other, one end portion is inserted into the through hole 37 of one of the lid-like members 3, the other end portion is inserted into the through hole 37 of the other lid-like member 3. As a result, the respective adjacent lid-like members 3 are connected to each other by the respective independent connection pipes 4. Therefore, when a load is applied to the adjacent gas tanks 2 and 5 by the expansion of the gas tanks 2 and 5, the adjacent gas tanks 2 and 5 are relatively easily moved, so that the load on the adjacent gas tanks 2 and 5 can be reduced. Further, at this time, since the connection pipe 4 can slide relative to the inserted lid-like member, it is possible to suppress the influence on the gas filling. Furthermore, since the seal members 7 are provided at both end portions of the respective connection pipes 4, the sealing property between the connection pipes 4 and the lid-like member 3 can be maintained even when the connection pipes are relatively slid.

Further, the gap 8 is provided between the adjacent lid-like members 3, since the connection pipe 4 has a flange portion 42 which enters the gap 8, it is possible to prevent the positional deviation of the connection pipe 4 using the flange portion 42, the insertion depth of the connection pipe 4 can also be restricted. That is, by using the flange portion 42, it is possible to prevent the connection pipe 4 from being excessively inserted into the through hole 37 of the lid-like member 3.

### Second Embodiment

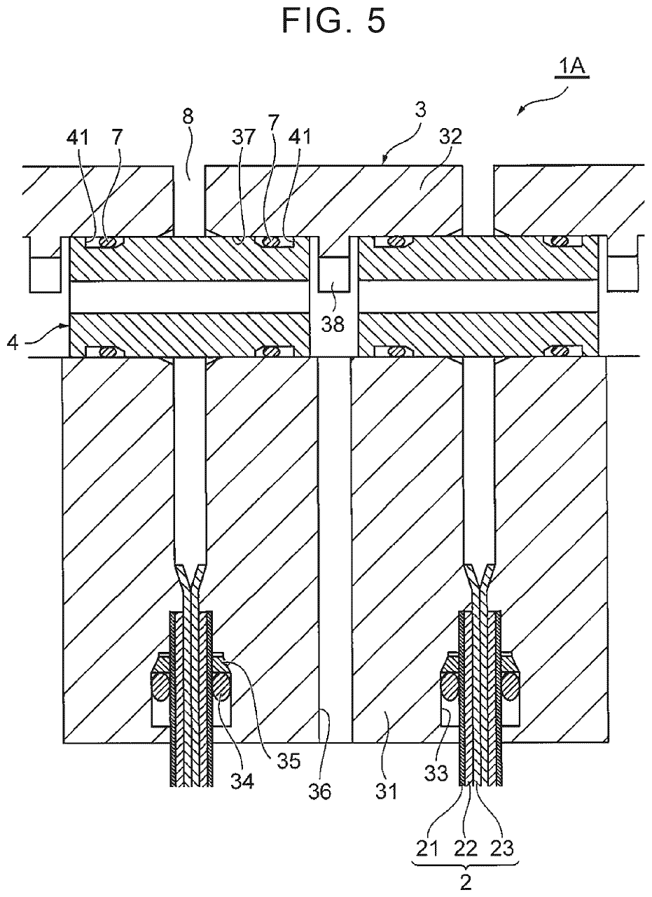

Hereinafter, a second embodiment of a gas tank structure will be described with reference to FIG. 5. The gas tank structure 1A of the present embodiment is different from the first embodiment described above in that the protruding portion 38 is provided in the lid-like member 3 instead of the flange portion 42 of the connection pipe 4. The other structures are the same as those of the first embodiment, and thus redundant descriptions thereof will be omitted.

FIG. 5 is a partial cross-sectional view illustrating a gas tank structure according to a second embodiment. As shown in FIG. 5, the connection pipe 4 is not provided with the flange portion 42. The inner peripheral wall of the lid-like member 3 is provided with a protruding portion 38 for regulating the position of the connection pipe 4 inserted into the through hole 37. The protruding portion 38 is disposed at a position opposite to the communication hole 36 in the inner peripheral wall of the lid-like member 3 forming the through-hole 37, and is provided over, for example, a range of an upper half of the inner peripheral wall.

According to the gas tank structure 1A of the present embodiment, the same advantageous effects as those of the first embodiment described above can be obtained. Further, by using the protruding portion 38 provided on the inner peripheral wall of the lid-like member 3, by regulating the position of the connection pipe 4, it is possible to prevent the positional deviation of the connection pipe 4, it is possible to suppress the excessive insertion of the connection pipe 4. Further, since the protruding portion 38 is disposed at a position opposed to the communication hole 36 in the inner peripheral wall of the lid-like member 3, it is possible to suppress the communication hole 36 being blocked by the connection pipe 4.

Although the embodiment of the disclosure has been described in detail above, the disclosure is not limited to the embodiment described above, and various design changes can be made without departing from the spirit of the disclosure described in the claims.

What is claimed is:

1. A gas tank structure comprising:
a plurality of gas tanks arranged side by side in one direction in a state in which adjacent gas tanks are in contact with each other;
a plurality of lid-like members provided in one-to-one correspondence with the gas tanks and mounted at respective ends of the gas tanks, the lid-like members each having a communication hole communicating with an inside of a corresponding gas tank and a through hole communicating with the communication hole and extending in a direction in which the gas tanks are arranged side by side;
a plurality of connection pipes that connects adjacent lid-like members to each other with one end of the connection pipes inserted into the through hole of one of the lid-like members and another end of the connection pipes inserted into the through hole of another of the lid-like members; and
a seal member provided at each of both ends of the connection pipes to seal between the connection pipes and the lid-like members.

2. The gas tank structure according to claim 1, wherein:
a gap is provided between adjacent lid-like members; and
the connection pipes have a flange portion that penetrates into the gap.

3. The gas tank structure according to claim 1, wherein a protruding portion that restricts a position of the connection pipes to be inserted is provided at a position facing the communication hole, of an inner peripheral wall of the lid-like members forming the through hole.
